(19) United States
(12) Patent Application Publication
(10) Pub. No.: US 2007/0244783 A1
(43) Pub. Date: Oct. 18, 2007

(54) Financial instrument viewer based on shared axes

(76) Inventors: William Wright, Toronto (CA); David Jonker, Toronto (CA); Brian Cort, Toronto (CA); Richard Brath, Toronto (CA)

Correspondence Address: Gowling Lafleur Henderson LLP, 1 First Canadian Place, Suite 1600, 100 King Street West, Toronto, ON, M5X 1G5, US

(21) Appl. No.: 11/783,826

(22) Filed: Apr. 12, 2007

Related U.S. Application Data
(60) Provisional application No. 60/791,219, filed on Apr. 12, 2006.

(51) Int. Cl. G06Q 40/00

(52) U.S. Cl. 705/35

(57) ABSTRACT

A method and system are provided for monitoring temporally dependent performance of at least one financial instrument in a marketplace including price and optional volume quantities for executed and unexecuted trades of the at least one financial instrument. The method and system include receiving temporally dependent financial data representing the price and optional volume quantities of the at least one financial instrument and determining a first common price scale configured for visually distinguishing the price quantities of both the executed and unexecuted trades and optionally determining at least one volume scale configured for visually distinguishing at least some of the volume quantities. The method and system also include determining a first plurality of shapes configured for visually distinguishing the executed trades on a trading activity surface and determining a second plurality of shapes configured for visually distinguishing the unexecuted trades on an order book surface, such that optionally each of the shapes of the first and second plurality of shapes are sized to correspond to the volume quantity associated with the trade represented by the shape, each of the shapes of the first and second plurality of shapes positioned on their respective surface with respect to the first common price scale to correspond to the price quantity associated with the trade represented by the shape. The system and method also include generating a visual representation configured for portraying the positioned shapes on a visual interface, such that the visual representation includes the trading activity surface located adjacent to the order book surface, such that the trading activity surface and the order book surface are visually aligned with respect to the first common price scale.

(This application claims priority from U.S. Provisional Application 60/791,219, filed Apr. 12, 2006, herein incorporated by reference.)

### FIELD OF THE INVENTION

This invention relates to analysis of investments.

### BACKGROUND OF THE INVENTION

Understanding financial market data is important for determining investment decisions. In a marketplace where prices are rapidly changing, better comprehension of all the related data can make the difference between success and failure for investment performance.

With regards to the visual depiction of the related financial data for a single financial instrument and across a plurality of financial instruments there is opportunity for improvement. Unfortunately, current display screens of financial market data for a single financial instrument either provide tables of numbers (e.g. a spreadsheet); or separate areas with different types of information displayed by different means, such as charts and graphs, tables and specialized visualizations such as treemaps. It is recognized, in liquid markets where many buyers and sellers are actively competing, that there is a lot of data and traditional display screens either display only a fraction of the data; or display different data in separate areas (e.g. trade data in a chart and order data in a table). In order to comprehend the situation, the viewer must compare data across the different areas. The viewer must match labels between items in different areas and mentally adjust for items at different scales, different units and/or different representations. It is recognized that with a large number of buyers and sellers actively competing, traditional spreadsheets and charts unfortunately only reveal a fraction of an investment picture. Typically the viewer of financial trading software needs to perform mental arithmetic to compare values on multiple screens because the viewer cannot visually compare time and volume between trades and orders quantities. The cognitive load can be reduced if the visual display locates the different data in a commonly scaled context and organized to facilitate visual comparison as opposed to mental comparison. Reducing the cognitive load enables potential faster situation assessment and faster response creating opportunity for more profitable trading in volatile markets. One example where rapid assessment is of value is a rapidly changing financial market such as the tech bubble bust of 2000, in which order book statistics were important to detect sudden shifts in the trading activity.

A further disadvantage with current investment analysis/tracking tools is the viewer needs to look at multiple charts, compare different labels and do mental arithmetic comparisons for different scales with respect to different data sets.

### SUMMARY OF THE INVENTION

It is an object of the present invention to provide a financial instrument monitoring system to obviate or mitigate at least some of the above-presented disadvantages.

A disadvantage with current investment analysis/tracking tools is the viewer needs to look at multiple charts, compare different labels and do mental arithmetic comparisons for different scales with respect to different data sets. On the contrary, a method and system are provided for monitoring temporally dependent performance of at least one financial instrument in a marketplace including price quantities for executed and unexecuted trades of the at least one financial instrument. The method and system include receiving temporally dependent financial data representing the price quantities of the at least one financial instrument and determining a first common price scale configured for visually distinguishing the price quantities of both the executed and unexecuted trades. The method and system also include determining a first plurality of shapes configured for visually distinguishing the executed trades on a trading activity surface and determining a second plurality of shapes configured for visually distinguishing the unexecuted trades on an order book surface, each of the shapes of the first and second plurality of shapes positioned on their respective surface with respect to the first common price scale to correspond to the price quantity associated with the trade represented by the shape. The system and method also include generating a visual representation configured for portraying the positioned shapes on a visual interface, such that the visual representation includes the trading activity surface located adjacent to the order book surface, such that the trading activity surface and the order book surface are visually aligned with respect to the first common price scale.

A first aspect provided is a method for monitoring temporally dependent performance of at least one financial instrument in a marketplace including price quantities for executed and unexecuted trades of the at least one financial instrument, the method comprising the acts of: receiving temporally dependent financial data including the price quantities of the at least one financial instrument; determining a first common price scale configured for visually distinguishing the price quantities of both the executed and unexecuted trades; determining a first plurality of shapes configured for visually distinguishing the executed trades on a trading activity surface and determining a second plurality of shapes configured for visually distinguishing the unexecuted trades on an order book surface, each of the shapes of the first and second plurality of shapes positioned on their respective surface with respect to the first common price scale to correspond to the price quantity associated with the trade represented by the shape; and generating a visual representation configured for portraying the positioned shapes on a visual interface, the visual representation including the trading activity surface located adjacent to the order book surface, such that the trading activity surface and the order book surface are visually aligned with respect to the first common price scale.

A second aspect provided is a system for monitoring temporally dependent performance of at least one financial instrument in a marketplace including price quantities for executed and unexecuted trades of the at least one financial instrument, the system comprising: an interface for receiving temporally dependent financial data including the price quantities of the at least one financial instrument; a configuration module for determining a first common price scale configured for visually distinguishing the price quantities of both the executed and unexecuted trades; a placement module for determining a first plurality of shapes configured for visually distinguishing the executed trades on a trading activity surface and for determining a second plurality of shapes configured for visually distinguishing the unexecuted trades on an order book surface, each of the shapes of the first and second plurality of shapes positioned on their respective surface with respect to the first common price scale to correspond to the price quantity associated with the trade represented by the shape; and an update module for generating a visual representation configured for portraying the positioned shapes on a visual interface, the visual representation including the trading activity surface located adjacent to the order book surface, such that the trading activity surface and the order book surface are visually aligned with respect to the first common price scale.

A further aspect provided is a computer program product for monitoring temporally dependent performance of at least one financial instrument in a marketplace including price and volume quantities for executed and unexecuted trades of the at least one financial instrument, the computer program product comprising: a computer readable medium programmed for implementing computer readable steps of the monitoring; an interface module stored on the computer readable medium for receiving temporally dependent financial data representing the price and volume quantities of the at least one financial instrument; a configuration module coupled to the interface module for determining a first common price scale configured for visually distinguishing the price quantities of both the executed and unexecuted trades and for determining at least one volume scale configured for visually distinguishing at least some of the volume quantities; a placement module coupled to the interface module for determining a first plurality of shapes configured for visually distinguishing the executed trades on a trading activity surface and for determining a second plurality of shapes configured for visually distinguishing the unexecuted trades on a book order surface, each of the shapes of the first and second plurality of shapes sized to correspond to the volume quantity associated with the trade represented by the shape, each of the shapes of the first and second plurality of shapes positioned on their respective surface with respect to the first common price scale to correspond to the price quantity associated with the trade represented by the shape; and an update module coupled to the interface and placement modules for generating a visual representation configured for portraying the positioned shapes on a visual interface, the visual representation including the trading activity surface located adjacent to the book order surface, such that the trading activity surface and the book order surface are visually aligned with respect to the first common price scale.

### BRIEF DESCRIPTION OF THE DRAWINGS

Exemplary embodiments of the invention will now be described in conjunction with the following drawings, by way of example only, in which:

FIG. 1 is a block diagram of components of an visualization environment for financial instrument data;

FIGS. 2 is a block diagram of an example computing device for hosting the components of a financial instrument data visualization tool of FIG. 1;

FIG. 3a shows an example embodiment a visual representation of FIG. 1;

FIG. 3b shows a further embodiment of an aligned surface of FIG. 3a;

FIG. 4a shows a further embodiment of the visual representation of FIG. 3a;

FIG. 4b shows a further embodiment of the visual representation of FIG. 4a;

FIG. 4c shows a further embodiment of the visual representation of FIG. 4a;

FIG. 5a shows an example visual representation of the system of FIG. 1 including multiple aligned surfaces with respect to common scales;

FIG. 5b is a further embodiment of the visual representation of FIG. 5a;

FIG. 5c is a further embodiment of the visual representation of FIG. 5b;

FIG. 6a is a further embodiment of the visual representation of FIG. 5a;

FIG. 6b is a further embodiment of the visual representation of FIG. 5a;

FIG. 7 is a further embodiment of the visual representation of FIG. 5b;

FIG. 8 is a further embodiment of the visual representation of FIG. 7;

FIG. 9a is a further embodiment of the visual representation of FIG. 7;

FIG. 9b is a further embodiment of the visual representation of FIG. 9a; and

FIG. 10 shows an example visualization tool of the environment of FIG. 1;

### DETAILED DESCRIPTION OF THE PREFERRED EMBODIMENT(S)

### Visualization Environment 1

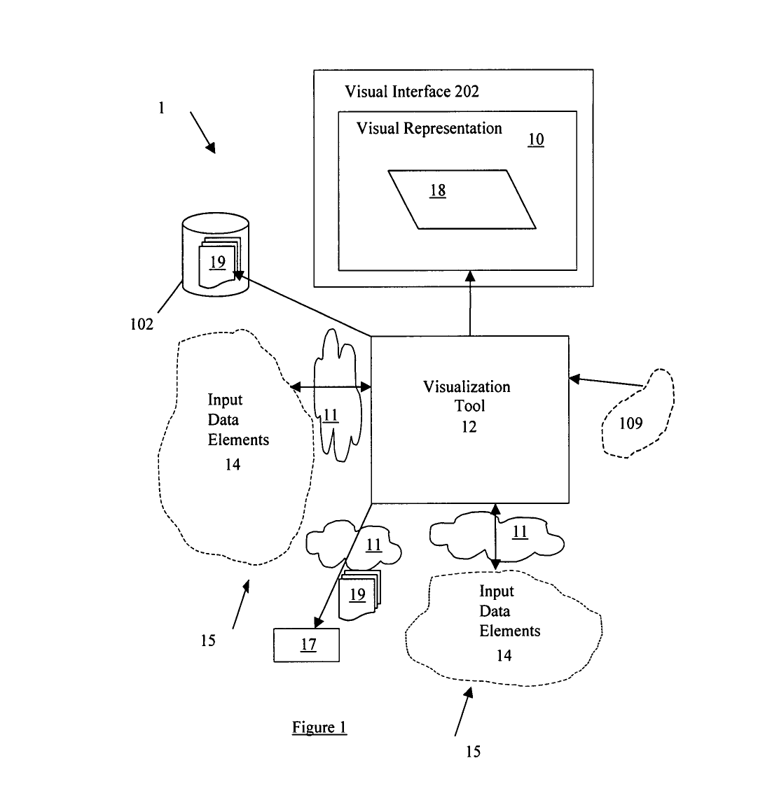

Referring to FIG. 1, a data visualization environment 1 includes a visualization tool 12 for processing a collection of financial instrument data 14 as input data elements to a user interface 202. The financial instrument data 14 is obtained (or otherwise received) from one or more data sources 15, e.g. public/private markets such as a stock exchange and/or reporting service for a stock exchange. The financial instrument data 14 is used by the tool 12 to generate an interactive visual representation 10 on trading activity for one or more financial instruments on a visual interface (VI) 202. The visual representation 10 includes a plurality of aligned display surfaces 18, as further described below.

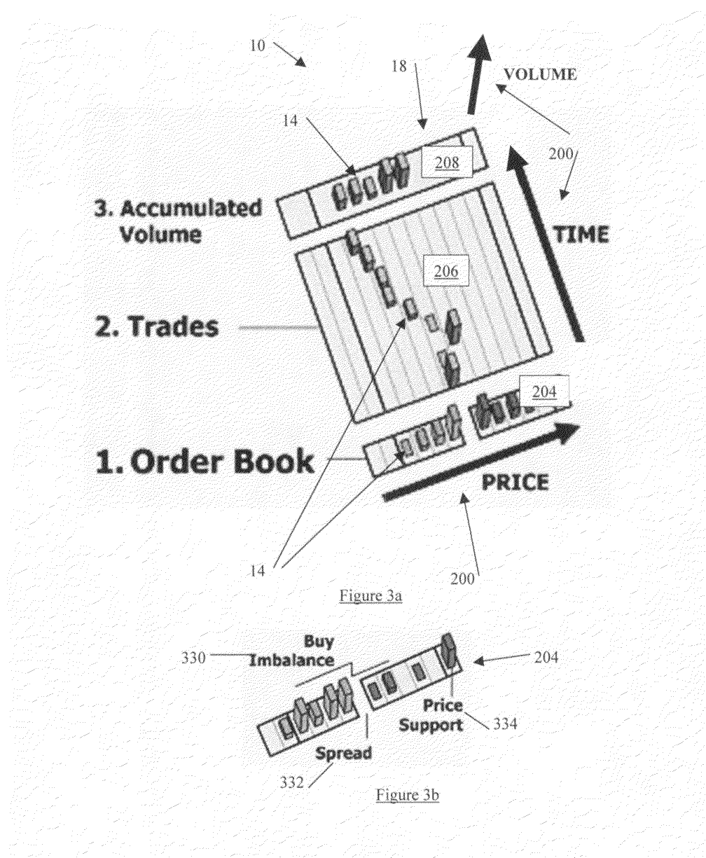

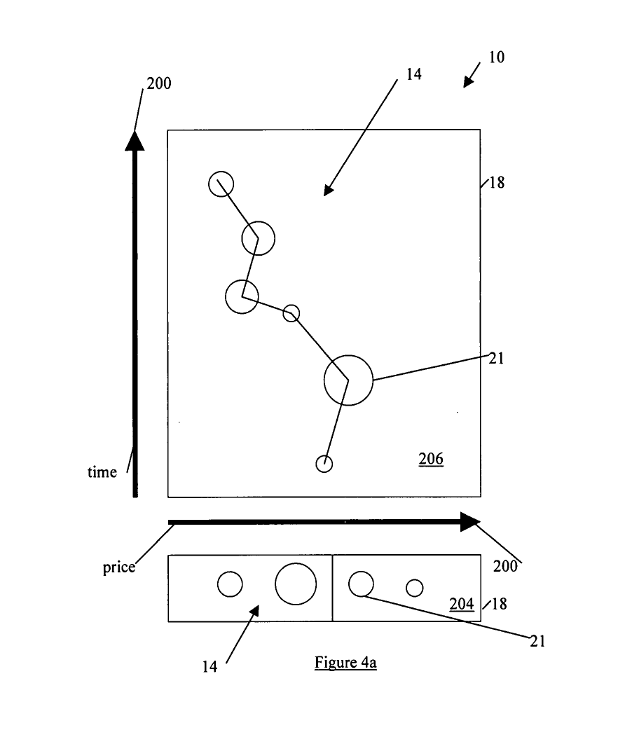

As further described below and with reference to FIG. 3a, the aligned display surfaces 18 (in either two or three dimensions) are aligned using one or more scales/axes 200 common between the different surfaces 18, which helps to reduce cognitive overhead of the user in interpretation of the data 14 displayed in the visual representation 10. For example, the visualization 10 displays both order book data 204 and trade activity data 206 aligned along the common price scale and aligned along the common volume (number of shares) scale. Further, shown is accumulated volume activity data 208 also aligned along the common volume and price scales. The user/viewer of the visual representation 10, generated by the tool 12, can visually compare price and volume back and forth between the trades, the orders and the accumulated volume, in order to facilitate the visual detection of patterns implicit in the selected financial instrument data 14. As can be seen, the aligned surfaces 18 are used to visually portray the financial data 14 for trade data (e.g. price-time, volume-time), order book data (e.g. stacked buy and sell orders for volume-price), and trade analytics including volume-price summary in the accumulated volume 208 and individual trade sizes in the trades 206.

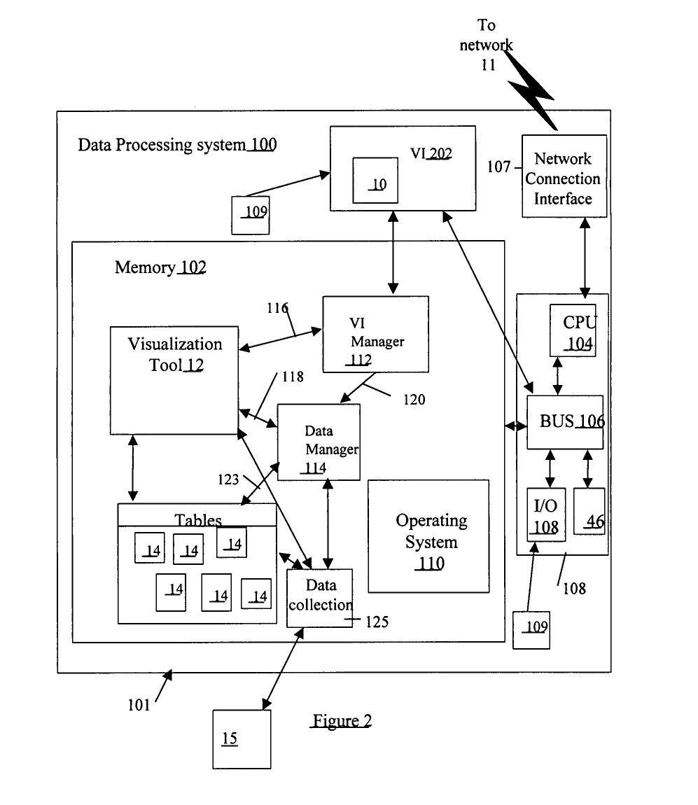

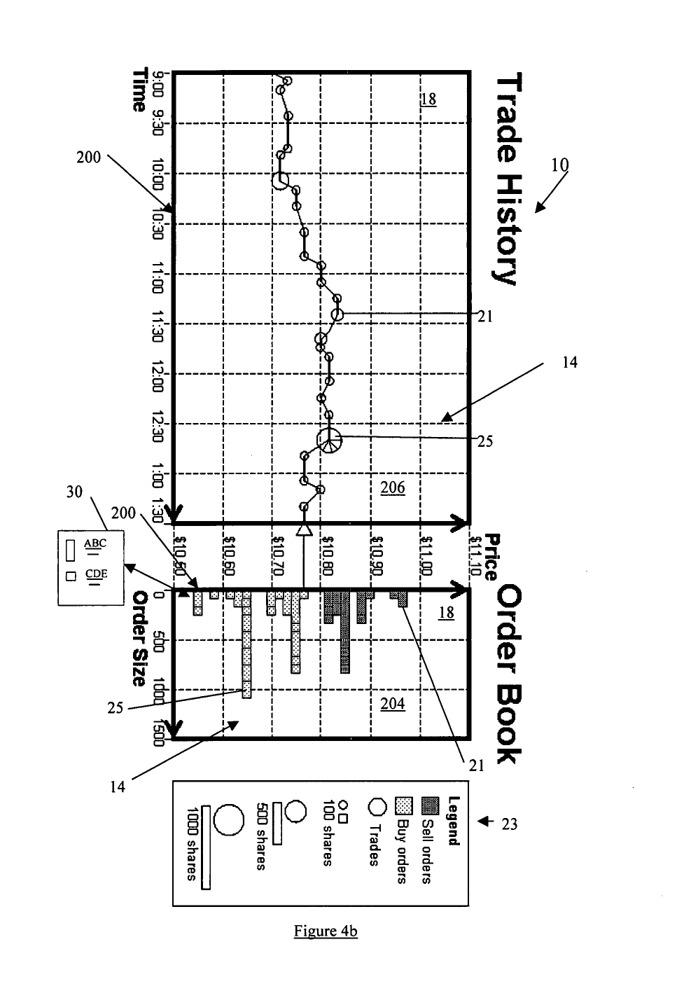

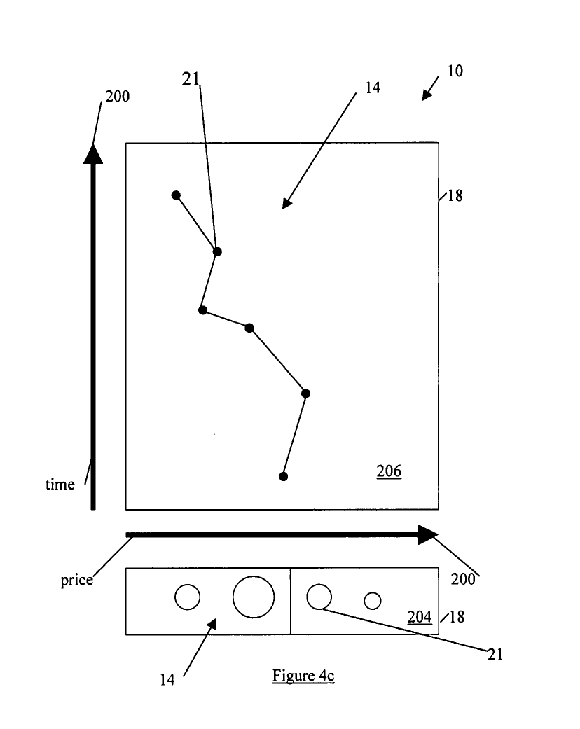

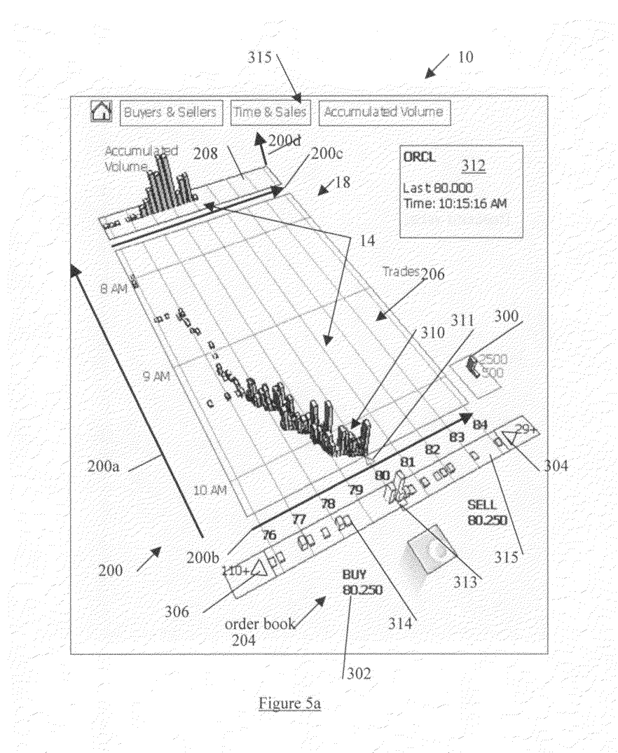

It is recognized that the dimensional aspect of the data 14 displayed on the aligned surfaces 18 can be as shown (e.g. three relative axes in three spatial dimensions) or can be shown (see FIGS. 4a,b) using two relative axes 200 in two dimensions, with trade volume depicted on the surfaces 18 (e.g. using circles or other shapes 21) such that the relative size of the shapes 21 represent a particular trade volume value in a common volume reference frame 23 (e.g. a legend). It is further recognised that the shapes 21 can be used to differentiate between separate trades of varying amounts that contribute to the size of the overall shape 21. For example, shown in FIG. 4b are circle shapes 21 in the form of pie chart sections 25 and bar shapes 21 having delineated stacked portions 25, such that the sections 25 can be used to represent individual trades grouped into an overall set of trades represented by the shape 21. It is further recognised that a user interface 108 (see FIG. 2), for example a cursor, can be used to select the shapes 21 and/or individual portions 25 from the visual representation 10. Once selected, further information 30 (e.g. text data on time, price, volume, company, trader, etc.) on the financial data 14 represented by the shapes 21 and/or portions 25 can concurrently (or separately) displayed to the user. This feature of displaying of further information 30 can be useful where the visual representation 10 is used to represent a summary of large amounts of financial instrument data, which can result in the initial display of only selected parts of the total available data on any particular data 204, 206, 208, for example. Accordingly, the user has access to any financial data 14 available that is associated with displayed visual elements on the visual representation 10.

In any event, it is recognized that the volume of the executed trading activity is directly embedded in the trading activity of the surface 18, for either two or three dimensional representation 10 depictions, along with an indication of price of the executed trades. Further, it is also recognized that the order book 204 surface 18, for open market orders (i.e. offers to buy or sell an amount (i.e. volume) of the financial instrument), is also aligned by the price scale in common with the surface 18 for the trade activity 206, wherein the portrayal of trade volume for each of the surfaces 18 is aligned (e.g. in common) also along the volume scale (in either two or three dimensions). Further, the visual representation 10 of the tool 12 is continually updated for the shown data 14 with respect to time, i.e. the time scale is continually updated in a conveyor belt fashion, as further described below. As well, the positions of the individual orders on the order book surface 18 with respect to the price scale 200, as well as the magnitude of the volumes (e.g. height of bars in FIG. 3 or the diameter/size of shapes in FIG. 4a,b) are continually updated to reflect temporal changes of the data 14.

Referring to FIG. 4c, shown is a further embodiment of the trading activity surface 206 without any indication of volume data embedded therein. It is understood that the alignment of the surfaces 204, 206 is still present with respect to the price axis 200b, without the display of volume data in the trading activity surface 206. Further, it is recognised that volume data of the financial instrument is present in the order book surface 204. It is recognised that display of the trading activity surface 206, without any display of volume data embedded therein, could also be applied to three-dimensional representations of the order book surface 204 combined with two-dimensional representations of the of the trading activity surface 206, as desired. It is recognised that the shapes 21 can be any of one-dimensional (e.g. a point), two-dimensional (e.g. a circle), and/or three dimensional (e.g. a bar), as desired. In the case of FIG. 4c, the shapes 21 are provided as points to visually represent the price quantity only, for example, for a respective executed trade.

Accordingly, the tool 12 can be used by the users for assisting in the making of trade decisions (i.e. purchase, hold, sell) for each of the financial instruments displayed in the visual representation 10, e.g. for facilitating optimized timing of trade decisions in the market(s). It is recognised that network components 101, 15, 17 (see FIGS. 1 and 2), further described below, of the environment 1 can communicate with one another via one or more networks 11, such as but not limited to intranets and extranets (e.g. the Internet) as desired.

The tool 12 is configured for facilitating the purchase and sale of the financial instruments of investment portfolios for one or more investing entities (e.g. users such as an individual, fund manager, etc.). The tool 12 can be used for generating reports 19 on the trading activity of one or more of the selected financial instruments represented by the data 14. The report 19 can include trade activity information such as but not limited to time period snap shots of the trading activity for one or more selected financial instruments—portrayed by the aligned display surfaces 18, derived trading statistics that is representative of one or more tracked trade quantities supplemented with the corresponding trade data 14 visualized on the display surfaces 18, etc. The report 19 can also include selected (either manually and/or automatically) available additional information 30 associated with the financial data 14 represented by visual elements in the visual representation 10. It is recognised that the report 19 can be provided as an electronic document and/or as a printed hard copy document, as desired.

The reports 19 can include financial data 14 information such as but not limited to: company name; financial instrument symbol (e.g. issue/trading symbol); trading activity for financial instrument price and corresponding times/dates (e.g. closing prices, midday prices, hourly prices, etc.) and volume with corresponding volume times/dates (e.g. closing volume, midday volumes, hourly volumes, etc.); average price of financial instruments of a particular class/category/sector for a particular time period; usual minimum trade quantity for financial instruments 12 in a particular class/category/sector; identity of traders for included trades; available trading statistics; available statistics on companies represented by the trades; and order book statistics (e.g. data related to price-volume for non-executed buy and sell orders).

### Financial Instrument Data 14

Financial markets can be defined by their characteristic nature of providing periodic/dynamic exchange-based valuation events. An example of the periodic/dynamic exchange-based valuation events are fluctuating or otherwise dynamically changing daily/real-time numbers for the volume and/or pricing, such as prices/volumes for buy/sell/bought/sold trading activities for financial instruments that are in the market environment handled as derivatives. Other periods can be weeks, months, quarterly, annual, etc. Any financial instrument traded in a public exchange can be connected to an underlying asset/liability of the issuing commercial entity (e.g. company) as a derivative. In general, the financial instrument data 14 is representative or financial instrument performance in a marketplace, in terms of price, time, and volume data characteristics. For example, the timing aspect of the data can be representative of the actual real-time (subject to any reporting delay) trading activity of a financial instrument (e.g. certain price for a certain volume occurring at a certain time), any historical trading activity of the financial instrument, and any future anticipated/desired trading activity of the financial instrument (e.g. order book data representing pending offer and sell trades not yet enacted).

The financial instrument data 14 can be from one or more sectors, such as but not limited to: trusts; oil and gas; energy related; food related; REIT; business; funds (e.g. diversified); selected stock exchanges or portions of stock exchanges (e.g. S&P/TSX 60 equities); and selected financial instrument types (e.g. Canadian bonds). The type of financial instrument data 14 can include financial instruments such as but not limited to, for example securities or security classes such as: common shares; preferred shares; debentures; convertible debentures; partnerships; closed trusts; open trusts; and exchange traded fund of funds. It is recognised that the markets are configured to provide a pricing mechanism for the financial instruments involving a series of pricing events (e.g. periodic/dynamic exchange-based valuation events) for each of the financial instruments that are available for selected periods of time, i.e. prices of individual financial instruments on the market are published or otherwise made available repeatedly (e.g. price of a stock with changes thereto posted in real-time with the ability to obtain past prices) as the financial instrument data 14.

For example, the scope of financial instruments can include: sectors; the market(s) involved; the type of financial instruments desired (e.g. all types, shares, debentures, partnerships, trusts, funds, etc.); particular financial instruments, a range of financial instruments within a chosen class/category, and/or sectors (e.g. selected companies, all Canadian stocks, all blue chip companies, etc.); and identification of company-issue in a number of dimensions such as fundamental descriptors (e.g. company/SEDAR name).

A book order of the order book 204 data can be defined as a request to buy or sell a certain volume of a security (e.g. financial instrument) at a specified/best available price. Most book orders executed on exchanges are referred to as market orders. The order book 204 can be defined as a record of unexecuted book orders which is maintained by specialists. These book orders are typically treated in terms of priority of execution. The book order to buy or sell a security, usually at a specified price, typically remains in effect until the order is either executed (i.e. committed) or cancelled. For example, the NYSE permits messages, as well as the book orders, to buy some amount of the financial instrument at current market prices. The OptiMark system of the Pacific Stock Exchange also allows traders to submit a message indicating the strength of the traders' desire to transact an amount of stock at a particular price, i.e. a book order. Types of book orders can be orders such as but not limited to: day order, stop order, limit order, market order, and stop loss order. Further, it is recognised that in most computerized markets, traders submit book orders to a central limit order book 204, and a mathematical algorithm determines prices and quantities.

The acceptance of a bid or offer (i.e. sell book order) by another trader (i.e. as a buy book order) generates a transaction, otherwise known as a trade. The trade can be a verbal (or electronic) transaction involving one party buying a security from another party. Once the trade is consummated, it is considered “done” or final. For example, settlement can occurs 1-5 business days once the trade has been executed (e.g. a committed trade). It is recognised that the book orders are displayed on the surface 18 representing the order book data 204, while the executed trades are displayed on the surface 18 representing the trading activity 206.

### Computer Devices 101

### Data Processing System 100

Referring to FIGS. 1 and 2, each of the components of the tool 12 and associated components can be implemented on one or more respective data processing systems 100 of computing device(s) 101, in order to facilitate visualization of the available financial instrument data 14. The data processing system 100 for the tool 12 has a user interface 108 for facilitating interaction with the tool 12 by a user, the user interface 108 being connected to a memory 102 via a BUS 106 of a device infrastructure 111. The interface 108 is coupled to a processor 104 via the BUS 106, to interact with user events 109 to monitor or otherwise instruct the operation of the tool 12 via an operating system 110.

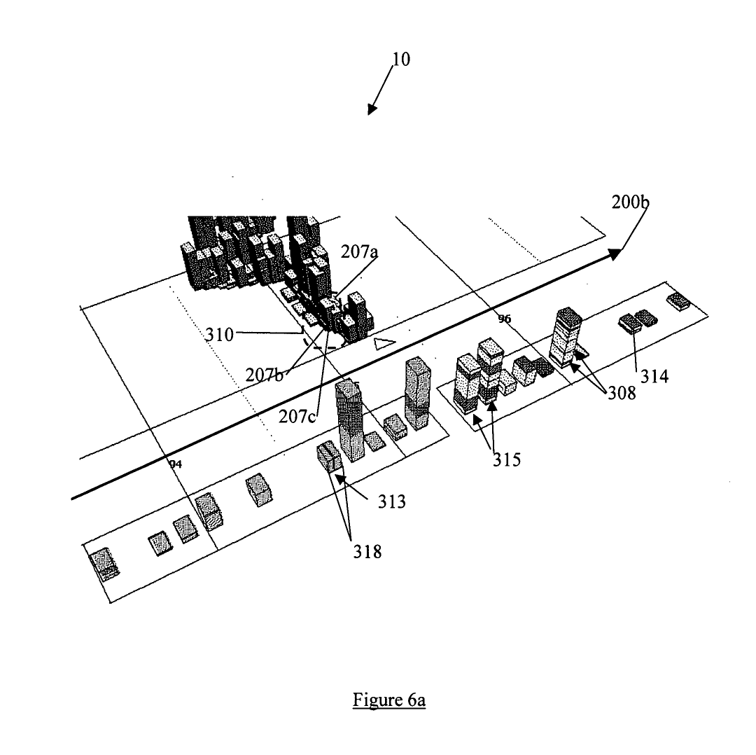

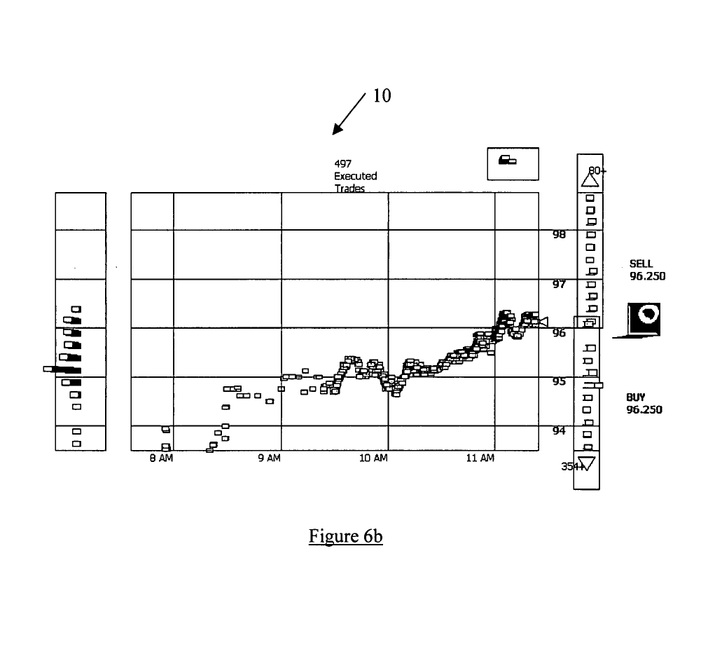

The user interface 108 can include one or more user input devices such as but not limited to a QWERTY keyboard, a keypad, a trackwheel, a stylus, a mouse, and a microphone. The visual interface 202 is considered the user output device, such as but not limited to a computer screen display. If the screen is touch sensitive, then the display can also be used as the user input device as controlled by the processor 104. Further, it is recognized that the data processing system 100 can include a computer readable storage medium 46 coupled to the processor 104 for providing instructions to the processor 104 and/or the tool 12. The computer readable medium 46 can include hardware and/or software such as, by way of example only, magnetic disks, magnetic tape, optically readable medium such as CD/DVD ROMS, and memory cards. In each case, the computer readable medium 46 may take the form of a small disk, floppy diskette, cassette, hard disk drive, solid-state memory card, or RAM provided in the memory 102. It should be noted that the above listed example computer readable mediums 46 can be used either alone or in combination. Further, it is recognized that the visualization tool 12 is an example embodiment of a financial instrument data 14 viewer application, which can contain a number of modules for implementing the various attributes and functionality associated with visualization of the data 14, as described with reference to FIGS. 2 and 6, for example.

The devices 101 include a network connection interface 107, such as a network interface card or a modem, coupled to the device infrastructure 111. The connection interface 107 is connectable during operation of the devices 101 to the network 11 (e.g. an intranet and/or an extranet such as the Internet), which enables the devices 101 to communicate with each other, report requestors 17, and with data sources 15 for obtaining available financial instrument data 14. The network 11 can support the communication of the reports 19. Referring again to FIG. 2, operation of the devices 101 is facilitated by the device infrastructure 111. The device infrastructure 111 includes one or more computer processors 104 and can include an associated memory 102 (e.g. a random access memory). The computer processor 104 facilitates performance of the device 101 configured for the intended task through operation of the network interface 107, the user interface 108 and other application programs/hardware of the device 101 by executing task related instructions. These task related instructions can be provided by an operating system, and/or software applications (e.g. tool 12) located in the memory 102, and/or by operability that is configured into the electronic/digital circuitry of the processor(s) 104 designed to perform the specific task(s) related to collection of the data 14, processing of the data 14 including visualization of the data 14, and generation of reports 19 of the data 14, as desired.

It is recognised that the report requestor 17 can also be the user of the device 101 hosting the tool 12, for example where the tool 12 is embodied as a local financial application executing on the user's device 101 and accessing the financial data 14 locally and/or remotely. Otherwise, the report requestor 17 can be the user of a remote device 101 that is connected to another device 101 hosting the tool 12 (e.g. client-server relationship), for example where the tool 12 is embodied as a remote financial application executing on a server device 101 in contact with the user device 101 over the network 11. In the client-server relationship, the tool 12 can be configured to access the financial data 14 locally and/or remotely.

Referring again to FIG. 2, the tool 12 interacts via link 116 with a VI manager 112 (also known as a visualization renderer) of the system 100 for presenting the visual representation 10 on the visual interface 202 of the data 14. The tool 12 also interacts via link 118 with a data manager 114 of the system 100 to coordinate management of the data 14 from data files or tables 122 of the memory 102. It is recognized that the data 14 could be stored in the same or separate tables 122, as desired. The data manager 114 can receive requests for storing, retrieving, amending, or creating the data 14 via the tool 12 and/or directly via link 120 from the VI manager 112, as driven by the user events 109 and/or independent operation of the tool 12. The data manager 114 manages the data 14 via link 123 with the tables 122. Accordingly, the tool 12 and managers 112, 114 coordinate the processing of data 14 and user events 109 with respect to the content of the screen representation 10 displayed in the visual interface 202. It is recognised that the tables 122 can be populated with data 14 obtained from a data collection module 125 in communication with the data sources 15, or the data 14 collected can be communicated directly to the manager 114 and/or tool 12, as desired. In particular, it is recognised that the functionality (e.g. responsible tasks) of the data manager 114 and the data collection module 125 can be combined, as desired. Further, it is recognised that the modules of the tool 12 (see FIG. 6) and the modules 112, 114, 125 of the data processing system 100 can be combined other than as shown, as desired.

Further, it is recognized that the computing devices 101 can include the executable applications (e.g. one embodiment of the tool 12) comprising code or machine-readable instructions for implementing predetermined functions/operations including those of an operating system, a web browser, for example. The processor 104 as used herein is a configured device and/or set of machine-readable instructions for performing operations as described by example above. As used herein, the processor 104 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 104 may use or comprise the capabilities of a controller or microprocessor, for example. Accordingly, any of the functionality of the system 100 may be implemented in hardware, software or a combination of both. Accordingly, the use of a processor 104 as a device and/or as a set of machine-readable instructions is hereafter referred to generically as a processor/module for sake of simplicity. Further, it is recognised that the system 100 can include one or more of the computing devices 101 (comprising hardware and/or software) for implementing the modules, as desired.

It will be understood that the computing devices 101 may be, for example, personal computers or workstations. Further, it is recognised that each device 101, although depicted as a single computer system, may be implemented as a network of computer processors, as desired.

### Memory 102

It will be understood by a person skilled in the art that the memory/storage 102 described herein is the place where data is held in an electromagnetic or optical form for access by the computer processor 104. There can be two general usages: first, memory is frequently used to mean the devices and data connected to the computer through input/output operations such as hard disk and tape systems and other forms of storage not including computer memory and other in-computer storage. Second, in a more formal usage, memory/ storage 102 has been divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is one embodiment of memory 102 as a collection of information that is organized so that it can easily be accessed, managed, and updated. In one view, databases can be classified according to types of content: bibliographic, full-text, numeric, and images. In computing, databases are sometimes classified according to their organizational approach. The most prevalent approach is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses. Computer databases typically contain aggregations of data records or files, such as sales transactions, product catalogs and inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory/storage 102 can also be defined as an electronic holding place for instructions and data that the computer's microprocessor 104 can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

### Visual Representation 10

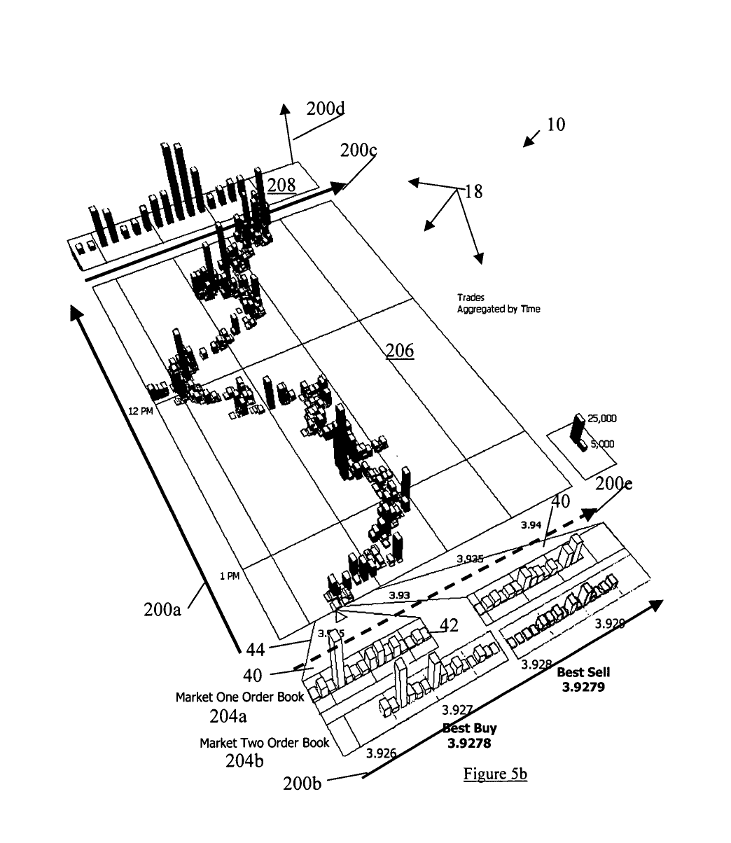

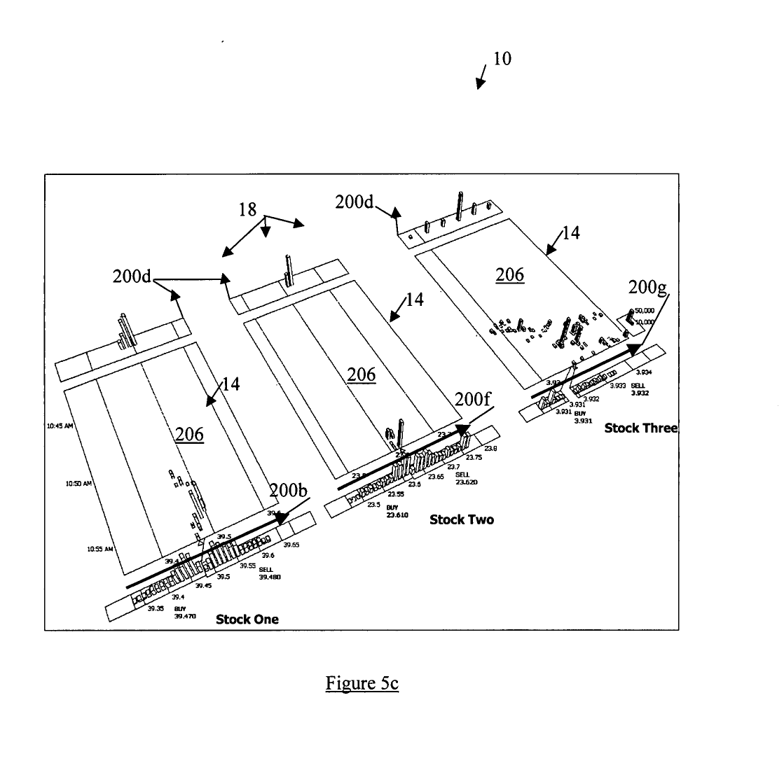

Referring to FIG. 5, shown is an example of the visual representation 10 showing three different aligned surfaces 18 for accumulated volume 208, executed trade activity 206, and order book 204 for representing pending trade activity. The visualization 10 of the tool 12 (e.g. an electronic marketplace viewer application) that provides useful financial data 14 as visually aligned elements for facilitating buyers and sellers to trade goods, such as financial instruments (e.g. stocks). It is recognized that with a large number of buyers and sellers actively competing, multiple traditional spreadsheets and charts unfortunately only reveal a fraction of picture. On the contrary, the representation 10 reveals, in real-time for example, several interrelated visual data elements (representing the financial data 14) about one or more marketplaces for one or more financial instruments. For example, the visual representation can be used to simply show the marketplace activities for one stock on one exchange, as shown by FIG. 5a, or can be used to show the marketplace activities for data 14 combined for two or more stocks (e.g. selected “composite” indexes) for one or more exchanges, as shown by FIG. 5b. For example, all stocks in a particular sector can be input as data 14 to the tool 12.

Referring again to FIG. 5b, shows two order books 204a,b for two different markets (e.g. NYSE and NASDAQ or NYSE and TSX). It is recognised that two or more financial instruments can be shown on the visual representation 10 as a combined display, such that the combination of the financial data 14 will be dependent upon visual clarity of the visual elements and the individual ranges for the time, price, and volume of the trades/orders for each of the financial instruments. For example, FIG. 5b shows shared surfaces 18 for the trade data 206 and volume data 208, with separate surfaces 18 for the order book data 204a,b. However, it is recognised that each of the respective aligned surfaces 18 for each of the data 204, 206, 208 could be shared or separated, as deemed appropriate for proper visualization of the financial data 14 on the visual representation 10. In any event, in the case of separate aligned surfaces 18 for any one aspect of the financial data 14 (e.g. order book data 104a,b), the surfaces 18 are still displayed as integrated with respect to one or more common scales 200, whenever possible, as further described below.

Depicted by example in FIG. 5b are common scales 200 between the aligned surfaces 18. These common scales 200 can include such as but not limited to: a time scale 200a for providing a selected or otherwise defined time period for the trading activity 206 for the two stocks; a price scale 200b for providing a price range between the order book 204a,b surfaces and the trading activity 206 surface; a volume scale 200d providing a common volume reference grid for volume magnitudes shown on any of the aligned surfaces 18; and a price scale 200c providing a price range between the volume 208 surface and the trading activity 206 surface. It is recognised that the alignment of the axes 200a, 200c, 200d is such that the “scale” of each axis 200 is experienced as the same between the individual aligned surfaces 18. For example, the scale of the volume axis 200d is a series of marks (e.g. graduated lines representing proportionate size) laid down at determinate distances, as along the axis 200d, for purposes of measurement or computation of the volume of the trades, such that the actual physical size of the volume shapes (e.g. the height of the bars) on the volume 208 surface and on the trade 206 and order book 204a,b surfaces is the same, as measured (e.g. via distance) between the same valued marks on the common volume axis 200d. The same can be said for the common time 200a and price 200c axes.

Referring again to FIG. 5b, it is recognised that the scale alignment of the order book 204b for the second stock matches the price axes 200b common between the trade activity surface 18 for both stocks trading 206 and the order book 204b. Due to spatial constraints of the visual representation 10 (e.g. dependent upon visual interface 202 size), the scale of the order book 204a is displayed using expanded portions 40 (e.g. the physical scale of an implicit price axis 200e for the order book 204a is larger that that of the price axis 200b), in order to facilitate the ability of visual distinction by the user between individual orders 42 on the order book 204a surface. In this case, it is recognised that the scale of the axis 200d is still common to the data 14 depicted by the order book 204a and the data 14 depicted on the other surfaces 18. Further, it is recognised that the extent of the price ranges represented by the orders 42 of the order book 204a are visually aligned through range delimiters/markers 44 (e.g. lines) that are positioned between the scale of the order book 204a represented by the axis 200e. Accordingly, it is recognised that the order book 204a and the trades 206 can still be defined as aligned surfaces 18 in view of the use of range delimiters/markers 44 used there-between. Further, it is recognised that the delimiters/markers 44 may be positioned at locations other than as shown at either extent of the order book 204a, for example for selected orders 42 or at other locations as desired.

Referring to FIG. 5c, shown are three stocks (stock one, stock two, stock three) for example in the visual representation 10, all aligned along a single common time scale 200a, single common volume scale 200d, and separate price scales 200b,f,g per stock. As compared to the financial data 14 depicted in FIG. 5b, the display of the financial data 14 in FIG. 5c is better suited visually to having three separate surfaces 18 for the trading activity data 206 of each of the stocks, based on the disparate values of the stock price ranges (e.g. 39.3−39.6, 23.4−23.8, and 3.930−3.935). However, it is recognised that the price scales 200b,f,g are used to align the respective aligned surfaces 18 of each stock in combination with the shared scales 200a,d common to all three stocks. It is recognised that two or more separate trading 206 surfaces 18 can be depicted in the visual representation 18, as desired with respect to suitable visualization considerations.

The visual representation 10 facilitates optimized timing of trade decisions in the market(s), and for implementing trades in the market(s) for those evaluated financial instruments, as desired. It should be recognised that the visual representation 10 of the financial instrument(s) is periodically updated on the information related to the market activity (e.g. number of stocks purchased/sold at what price). Updating of the representation 10 can be done continuously as changes in displayed quantities are detected, e.g. real-time, or for a predefined periodic based update, e.g. time based such as for every two minutes, or action based such as for when new orders/trades over a specified threshold (e.g. volume/price) are detected. It is recognised that in updating of the financial data 14 visually depicted in the visual representation 10, changes in the visual elements would be detectable by the user, changes such as but not limited to: size of the visual elements (e.g. due to scale change of the volume axis 200d); location of the visual elements on the surfaces 18 (e.g. due to changes in scale of the time axis 200a), number of visual elements on the surfaces 18 (e.g. due to addition/deletion/changes to trades/orders); and/or scale of the axes 200 (e.g. changes to numerical labels).

Accordingly, with this single representation 10, the user can see both the current level of activity by buyers and sellers, the movement of the market over the course of the day, and/or the price levels that are sustainable with significant volume. The user/viewer does not need to look at multiple misaligned charts, compare different labels and do mental arithmetic comparisons for different scales of different misaligned charts for understanding trading activities represented by the financial instrument data 14, at least in part due to the use of one or more common scales 200 between the aligned surfaces 18. These common scales 200 can include such as but not limited to: a time scale 200a for providing a selected or otherwise defined time period for the trading activity 206; a price scale 200b for providing a price range between the order book surface 204 and the trading activity surface 206; a volume scale 200d providing a common volume reference grid for volume magnitudes (e.g. height or other dimension/size of shape object representing volume—e.g. height of bars 314) shown on any of the aligned surfaces 18; and a price scale 200c providing a price range between the volume surface 208 and the trading activity surface 206.

Referring again to FIG. 5a, a number of related quantities (to the specific trade 206, volume 208 and order book 204 displayed quantities) can be displayed concurrently on the representation 10. These can include quantities such as but not limited to: order book volumes 300 for closest buy and sell orders or groups or orders, e.g. first 10 of each; current highest buy and lowest sell prices 302; number/volume of sell orders 304 not shown/displayed in the price range of the order book surface 204; number/volume of buy orders 306 not shown/displayed in the price range of the order book surface 204; differentiation 308 (see FIG. 6a) between individual orders in the order book 204, for example different coloured bars 314 (for indicating orders and/or trades) stacked for the same price within a price grouping 315 of the price scale 200b as well as different bars 318 positioned adjacent to one another in the same grouping 313 based on relative price differentiation within the grouping 313; bar clustering 310 in the trade surface 206, which represents individual trades of differing volumes (for example) occurring at a similar time (e.g. the same time value and/or an equivalent time within a specified timescale tolerance—all trades are placed at the same representational time value for those trades that occur within say 15 seconds of the representative time value); indication 311 for the last trade price of the trades on the trading surface 206 with respect to the price scale 200b; gap 313 between the prices of the highest buy and lowest sell order of the order book surface 204; displayed information 312 on the most recent trade of selected financial instrument(s) represented in the data 14 shown on the surfaces 18; and selection menus/buttons 314 for manipulating the visual emphasis of the data 14 displayed in the representation 10, e.g. close-ups of various surfaces, change in orientation of the surfaces 18 (see FIG. 6b) with respect to the view point of the user, and changes to the ranges of the price/volume/time shown by the scales 200.

It is recognised that the clustering 310 can be used to represent a number of individual trades 207a,b,c as overlapping/adjacent shapes on the surface 18 for trades such as but not limited to: trades 207a,b,c occurring for the same “time” at slightly different prices; trades 207a,b,c occurring at slightly different times for slightly different prices; and/or trades 207a,b,c occurring at the same time for the same “price”, as desired. Further, it is recognised that the clustering 310 can be shown as additional information 30 (see FIG. 4b), as desired. The definition of same time and same price can include times and prices with actual different numerical values but aggregated together under one representative time/price (e.g. three trades at different times of 3:01 pm, 3:02 pm and 3:03 pm are all displayed on the surface 18 as time 3:00 pm). In any event, it is recognised that any financial data 14 that is not discernibly displayed in the visual representation 10 at any one time could be accessed by the user via user events 109 (see FIG. 2), e.g. through the display of additional information 30 (see FIG. 4b).

Further, it is recognised in FIG. 6a that the differentiation 308 of stacked bars 314 within the same grouping 315 can represent multiple orders/trades at the same/similar price. Further, the bars 314 can be stacked in priority, i.e. the first order/trade is at the bottom and additional orders/trades are placed on top.

Referring again to FIG. 5a, it is recognised that the bars 314 can be colour coded (or use of other visual distinction, e.g. shading, etc.) to represent different types of the data 14 (e.g. green for buy orders, red for sell orders, purple for executed trades, and gold for my orders in the order book 204, which in turn become gold trades 206 when the execute). Further, colour coding can be used by the indication 311 for portraying a characteristic of the last trade activity (e.g. green for up-tick and red for down-tick). It is also recognised that a mouse-over (e.g. with subsequent display of the additional information 30—see FIG. 4b) or other selection technique can be provided by the tool 12 to display trading details represented by any particular shape (e.g. bars 314), such as exchange for trade, trade time, trade price, trade volume, related to trades by the same buyer/seller, etc. Referring to FIG. 3b, also shown can be identifiers for particular trading characteristics, for example for the order book 204 related identifiers of buy imbalance 330 (more orders on one side), spread 332 (size of gap between buy and sell orders), and price support 334 (large orders at price points—e.g. exceeding predefined order size/price thresholds), which can include text, graphical symbols (e.g. lines) and/or numbers for defining these characteristics as displayed on the representation 10 (by default or by active selection by the user—e.g. mouse-over). It is recognised that the identifiers can be used to help the user to visually detect patterns in the data 14 (e.g. between the book and trades, such as whether an increasing price trend is supported by an order imbalance, or if the price movement will stop at a support point). Accordingly, it is recognised that the visual representation 10 can use various visual distinction techniques (e.g. colour, shading, etc.), other than described above, for differentiating different meanings/interpretations between similar visual elements displayed (e.g. own trades 206 coloured differently from other third party trades 206).

### Combined Display of Trade/Order and Trade/Accumulated Volume in the Representation 10

The tool 12 visualizes order book and trade data. The bottom of the representation 10 in FIG. 5a (the foreground), shows all the orders on the book order surface 206. The orders are organized by price according to the shared price axis 200b, e.g. the orders are lined up from left (low prices) to right (high prices) at defined price intervals. The BUY orders can be on the left in green, for example; and the SELL orders can be on the right in red, for example. In the middle of the orders can be the highest buying price and the lowest selling price forming the “inside quote”. Trades will occur at either of these two prices, or in between these two prices as desired.

The trade surface 206 section of the representation 10 updates with each new trade shown as a respective 3-D bar (for example) of height specified by the volume of the trade as defined by the volume axis 200d. The trade surface 206 is similar to a price chart—with the long axis 200a indicating time and the shorter axis 200b indicating price. After each update interval as per the update module 410, if there has been a new trade, a new bar 314 will appear at the right end of the trade surface 206 indicating the last trade price. Similarly, as time progresses for each update of the visual representation 10, any older trades that fall outside of the specified time range of the time axes 200a will effectively drop off at the left end of the trade surface 206. Accordingly, the sequence of bars 314 over time shows the trade history (for example for the last 2 and a half hours indicating how the trade price has changed over time), as per the defined range of the time scale 200a. Further, the operation of adding new trades on the trade surface 206 at the right end (e.g. current time) of the time scale 200a, repositioning the individual trades along the trade surface 206 to account for the incremental advance in time, and removing of the oldest trade(s) from the trading surface 206 at the left end (e.g. oldest time) of the time scale 200a, results in the visual effect of a conveyor belt or shifting surface 206 with respect to time for the trades. For example, with a specified static time range of 2 hrs for the time scale 200a, a new trade would appear at the far right of the trading surface 206 at 2 pm, would be at the middle of the trading surface 206 at 3 pm, and would be at the far left of the trading surface 206 at 4 pm. Similarly, all other trades on the trading surface 206 would move/shift with respect to one another, relative to the common time scale 200a (e.g. temporal reference frame).

It is recognised that the time range could be defined as a static value, could be dynamically calculated in relation to trading activity, or a combination thereof. For example, the time range could be specified to vary between 2-3 hrs depending upon the amount (a certain threshold) of trading activity. For example, for stocks with large trading volumes for numerous different trades, the time range could stay close to the lower of the-specified time range (e.g. 2 hours), as compared to thinly traded stocks the time range could extend closer to the higher of the specified time range (e.g. 3 hours) in order to keep a certain volume/number of trades visible in the visual representation 10.

Other features include: the height of each bar 314 indicates the number of shares traded in that interval. A legend 300 at the far right indicates the approximate size of a bar 314 for 500 and 2500 shares. The triangle 304 at the far right of the “SELL” region indicates the last trade price. It can flash red, for example, if the last trade is below the previous trade; and it can flash green, for example, if the last trade is above the previous trade. The back of the representation 10 at the “ACCUMULATED VOLUME” surface 208 shows the total number of shares traded at each price interval since the tool 12 has been running for a specified session. This provides a visual distribution of the price levels that the stock has been trading at; and indicates, for example, which price most of the shares were traded at; as well as which prices had very few shares traded at. It is recognized that the volumes shown in the surface 208 may represent more that what a simple addition is for the volumes of the currently displayed trades in the trade surface 206, thus giving a perspective of trade history other than what is currently shown in the trade surface 206.

### Visual Alignment of Volume and Price Axes.

Traditionally, people look at trade history 206 separate from the order book 204 data. This would require the viewer to perform label matching and mental arithmetic when comparing these two datasets, when not using the described data visualization environment 1. Accordingly, the representation 10 displays both the order book 204 and the trade 206 data aligned along the price scale 200b and aligned along the volume (number of shares) scale 200d. The viewer does not need to perform label matching because the items are visually aligned, nor mental arithmetic to compare values because the items are at a common scale. The viewer can now visually compare time and volume back and forth between the trades 206 and orders 204. Because visual comparison is typically faster and easier to accomplish than label matching and mental arithmetic, the user can spot patterns of the displayed data 14 more easily than using traditional charts and graphs or quote screens. Visual manipulation of the data 14 with respect to multiple aligned axes 200 is done by techniques such as but not limited to: visual alignment of price axes 200a in orders 204 and trades 206 groups; with use of colored zones to call out the visual relationship when the two scales 200 are different; visual alignment of price axes 200a in trades and accumulated volume; visual alignment of the volume axes 200d in the orders 204 and trades 206 groups; and visual alignment of the volume axes 200d in the trades 206 and accumulated volume 208.

### Visual Depiction of the Spread in Groups as a Gap

The gap 322 (see FIG. 3a) between the highest buy order and lowest sell order is called the spread, and is visually represented by a visible gap between the two in the representation 10. Buy orders are colored green and sell orders are colored red, for example. The number of shares for buy (or sell) at any price level is indicated by the height of the bar 314. Various patterns may be detected visually in the order book 204 from time to time. For example: a large spread is indicated by a big gap between the best buy order and the best sell order; a narrow spread is indicated by a small gap or no gap between the best buy and best sell; bias is indicated with larger bars on one side of the book; price support may be indicated by a single large bar at one price level. This gap 322 can be visually distinguished due to the alignment of the individual book orders 204 with the price gradients of the price axis 200b. Further, stacked bars 314 may indicate a number of orders attempting to marginally improve the price within one price bucket/group.

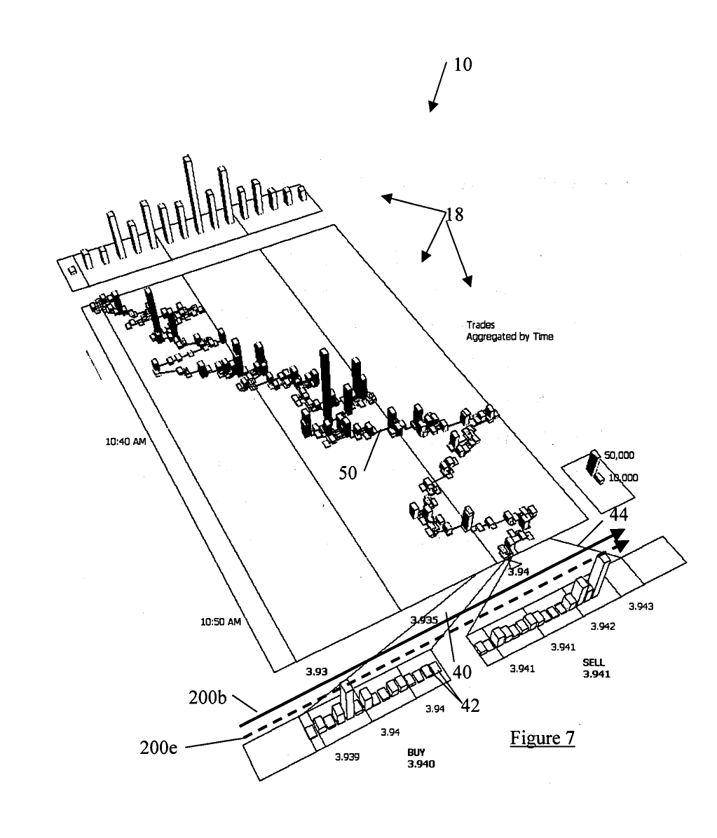

Referring to FIG. 7, shown is a further view of scale alignment of the order book 204a as shown in FIG. 5b. Due to spatial constraints of the visual representation 10 (e.g. dependent upon visual interface 202 size—see FIG. 2), the scale of the order book 204a is displayed using expanded portions 40 (e.g. the physical scale of an implicit price axis 200e for the order book 204a is larger that that of the price axis 200b), in order to facilitate the ability of visual distinction by the user between individual orders 42 on the order book 204a surface. Further, it is recognised that the extent of the price ranges represented by the orders 42 of the order book 204a are visually aligned through range delimiters/markers 44 (e.g. lines) that are positioned between the scale of the order book 204a represented by the axis 200e. Accordingly, it is recognised that the order book 204a and the trades 206 can still be defined as aligned surfaces 18 in view of the use of range delimiters/markers 44 used there-between. Further, it is recognised that the delimiters/markers 44 may be positioned at locations other than as shown at either extent of the order book 204a, for example for selected orders 42 or at other locations as desired.

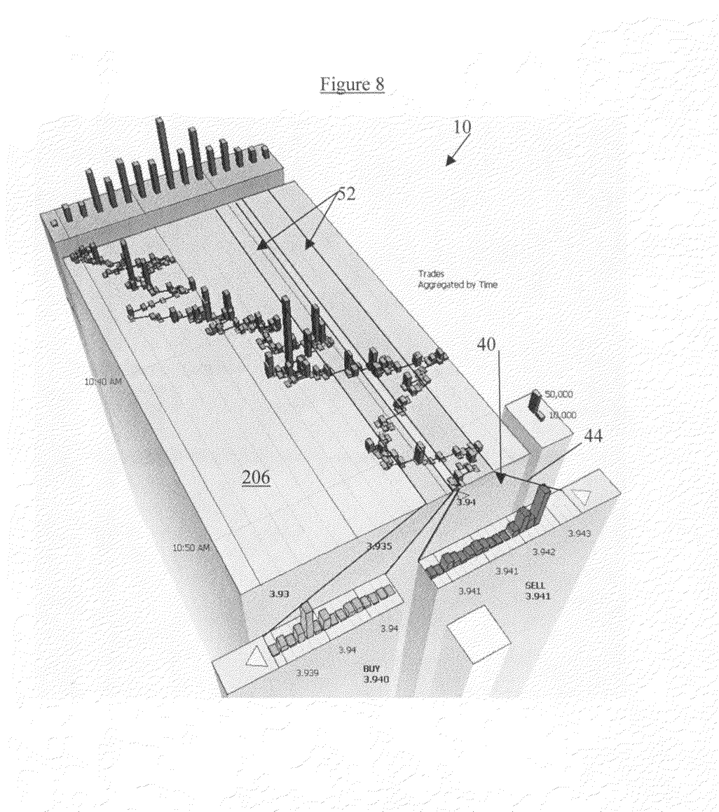

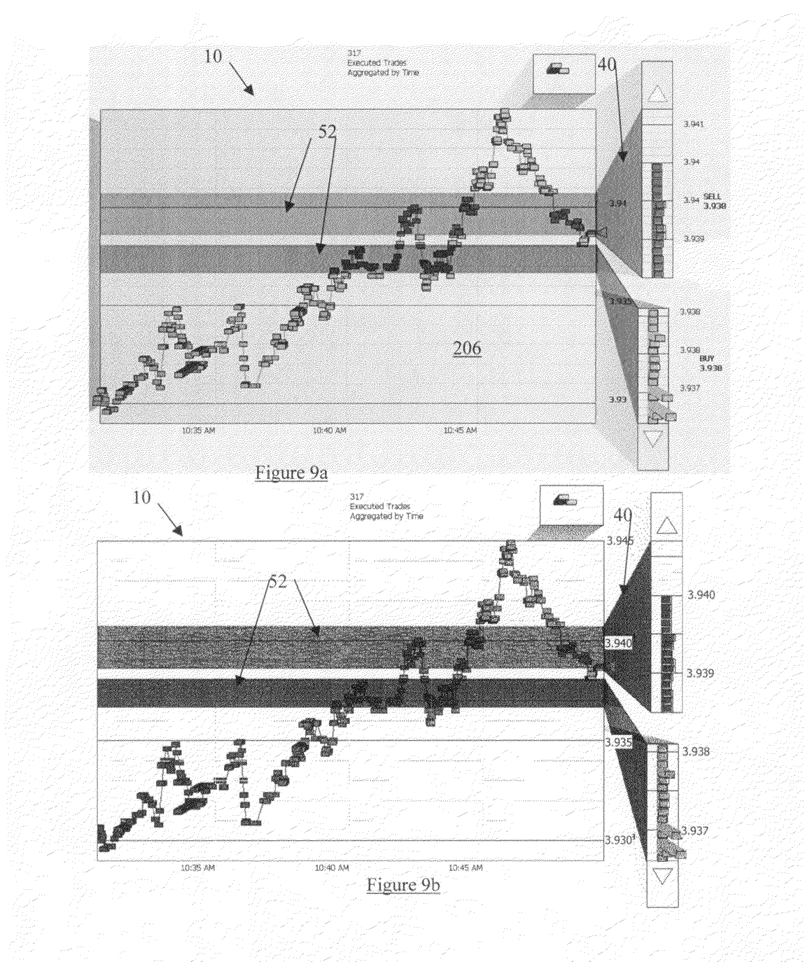

Referring again to FIG. 7, operation of the tool 12 enables different price scales 200b and 200e between the book orders 204 (non-committed trades) and the trades (committed trades) of the trading activity 206, e.g. linked visually with diagonal lines as markers 44, while facilitating the maintenance of interpretive alignment between the respective surfaces 18. This use of the visual markers 44 to facilitate a contextual connection/continuity between similar axes 200b,e, of different scales, can be used if the trade prices vary a lot, while the order book price range is fairly tight/narrow. Otherwise, if a single trade scale were used, all the orders would be compressed into a tiny region, which would be difficult for the user to visually distinguish individual book orders on the book order surface 204. Further, it is recognised that a visual indicator 50 (e.g. a line) can be used to join or otherwise visually connect the trades together on the trading activity surface 206 to help indicate the price history (i.e. which committed trade was done before the other adjacent committed trade). It is recognised that the markers 44 can also be referred to such names such as but not limited to: call-outs; leaders; visual indicators; and visual connectors, as desired. Further, referring to FIGS. 8 and 9a,b, shown are examples of an indicator region 52 that is associated with the expanded portions 40 related to the markers 44. The indicator region 52 can be embodied as a differently coloured/shaded zone than the rest of the trading activity surface 206, and/or a series of visually discernable lines, so as to help visually distinguish the price range of the order book 204 surface represented on the surface of the trading activity 206. Accordingly, the use of the indicator region 52 provides for further alignment/correlation of the data 14 represented on the order book 204 surface with the data 14 represented on the trading activity 206 surface, in the case where the scale of the price axes 200b,e is different. It is recognised that the expanded portion 40 is visually connected to the indicator portion 52, for example as shown in FIGS. 8 and 9a,b.

### Visualization Tool 12

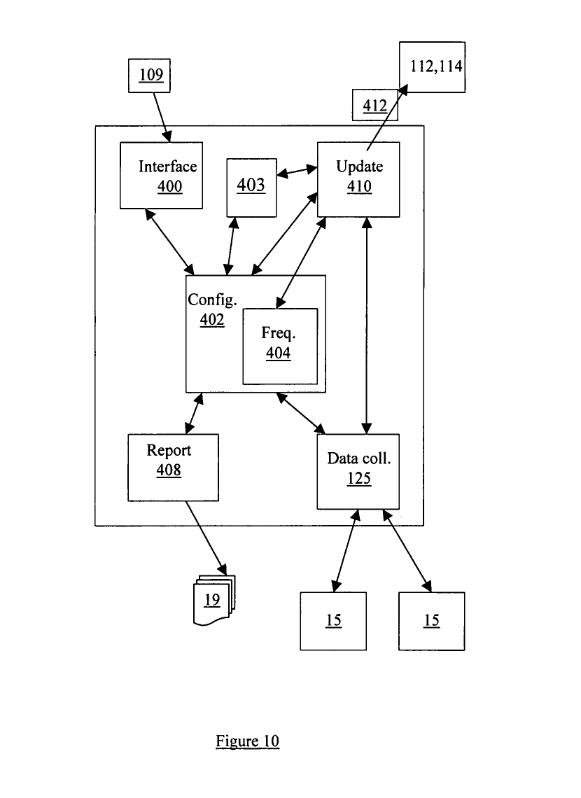

Referring to FIG. 10, shown is an example visualization tool 12. It is recognised that the above-described functionality and features of the visual representation 10 (and operation thereof) can be implemented by any one or more of the tool 12 modules described herein. The tool 12 has an interface module 400 for interacting with events 109 of the user and/or an administrator of the tool 12. Coupled to the module 400 is a configuration module 402 for setting up the operation of the tool 12, including desired data 14 format of the representation 10 and range of the axes 200, as further described below, as well as for predefining groupings of financial instruments for display as a composite visual representation 10. A placement module 403 is used to coordinate the placement of the surfaces 18 with respect to the determined axes 200. A frequency module 404 is used for determining the desired update frequency of the data 14 displayed in the representation 10, in connection with a data collection module 406 responsible for obtaining/receiving the data 14 sent from the sources 15. Also included is a report module 408 for use in generating reports 19. These is an update module 410 in communication with the modules 125, 400, 402, 404, 406 in order to provide update data 412 (amended versions of the data 14 already displayed in the representation 10) to the managers 112, 114.

### Data Collection Module 125

Referring again to FIG. 10, the data collection module 125 is configured to facilitate the collection of the data 14 from the sources 15 according to defined collection frequencies, as desired, as specified by the frequency module 404. The module 125 is coupled to the update module 410 (see FIG. 10) for providing the data 14 for use generating of otherwise updating the visual content of the representation 10. The module 125 also provides data 14 to the configuration module 402 for those data 14 that require pre-processing for desired format or other calculated quantities as a combination of the data 14, before being made available to the update module 410.

Examples of the data sources 302 include, for example, sources such as but not limited to selected exchanges (e.g. TSX, NYSE); financial services (e.g. Bloomberg, Thompson); and third party information sources.

### Configuration Module 402

The configuration module 402 is for setting up the operation of the tool 12, including desired data 14 format of the representation 10 and range of the axes 200. The module 402 can be responsible for autosizing of the range of the axes 200, for example the maximum physical height of the bars 314 (see FIG. 5a), the change in displayed price range due to the content displayed on the aligned surfaces 206 and 204, as well as changes in the temporal range displayed for the data 14 on the surface 206. In particular, the time range can be due in part to changes in the volume and prices of individual trades as well as the change in book orders in terms of price point. Accordingly, the axes 200 change in scale to keep the desired information of the data 14 in view on the representation as linked to the dynamic updating activity aspect of the data due to variations in trading activity. In any event, it is recognised that selected axes can have their range calculated based on the characteristics of both adjacent surfaces 18 sharing the common axes 200.

For example, the shared price axis 200b can be a combination of last trade price of the trades 206, number of orders in the order book 204, the range of orders in the order book 206, and/or the range of trade prices of the trades 206 for the period of time shown. Further, the volume axis 200d range can be a combination of the target order at the price in the order book 204, and the largest trade volume of the trades 206 in the price interval represented by the price range. The range for the time axis 200a can be set for a particular number of trades 206, a particular total volume of trades 206, and/or a selected period of time (e.g. morning, day, hour, etc.). For example, for thinly traded financial instruments the time range of the time scale 200b may be more weighted for number of trades/volume, rather than for a more actively traded financial instrument which may be more weighted for a selected time period irrespective of any significant influence on the time range of the actual trading activity.

Accordingly, the determination of the scales for the various axes 200 is calculated so as to enable alignment of the individual surfaces 18 with respect to shared axes 200 between two or more of the surfaces 18. In determination of the scales, characteristics of the data 14 are taken into account, for example from data 14 represented on two of more surfaces 18 sharing a common axis 200.

Further, it is recognised that an algorithm can be used to group orders/trades into regular intervals of the axes 200, so that the common axes 200 show a range relevant to the current data 14 being viewed, and so that it can labelled with nice round numbers (e.g. 3.00 instead of 3.02123) which will facilitate visual comparison, as well as for calculating the ranges of the axes base on dependent variables. Considerations for the algorithm are, for example: we have a target of the ideal # of bins that should be shown (e.g. 40) on a particular axes 200; hinder multiple orders in the same bin; hinder overlap between the inside buy and sell orders; show as many orders as possible; hinder outlier orders skewing the presentation of orders close to the market price; always show the inside orders; minimize the visual changes between data updates (each data update contains an entirely new order book). It is recognized that the binning process can also be controlled so as to facilitate visual clarity of the individual trades occurring on the trading surface 206.

An example algorithm is as follows:

```
Given the list of buy and sell orders
Find the spread
Find the minimum increment (i.e. bin size) we're interested in:
  If there is more than one buy order or sell order, then find the minimum of these
  values and the spread
  Else use the spread
Determine a low cut-off value:
  Take the maximum of:
    The middle of the spread minus a percentage of the price (e.g. 5%)
    The middle of the spread minus the calculated minimum increment *
    ideal#bins * .6
Determine a high cut-off value:
  Take the minimum of:
    The middle of the spread plus a percentage of the price (e.g. 5%)
    The middle of the spread plus the calculated minimum increment *
    ideal#bins * .6
Find the min/max order prices
If the min/max prices are outside the cut-offs:
  If there is an order closer to the spread within the cutoffs → assign to min/max
  price
  Else, if there is an order on that side (buy/sell) regardless of cutoff → assign to
  min/max price (this means we can show the inside quotes regardless of whether
  they would be hidden by the other heuristics)
  Else assign the cut-off to min/max price
If this is not the first binning procedure for the given stock:
  Use linear interpolation to move the min/max boundaries of the previous frame
  part of the distance to the calculated min/max boundaries (e.g. 40%)
Discretize the binning according to the size of the bin increment from the previous frame
(or the default value if it's the first time through)
  This means that if the bin increment is $1 per bin, then we want the bin edges to
  fall on even dollar amounts
Add an extra bin to the max edge to provide for numerical imprecision
If the number of bins is outside a percentage range of the ideal number of bins, then
REBIN. (e.g. if there are more than 5/3 * ideal#bins or less than 2/3 * ideal#bins
```

This value is compared to a similar algorithm across a list of trades and the larger number of bins is used. If the difference in the number of bins for the trades is much larger than the number of bins for the orders, then the orders will have an independent order price axis, visually correlated to the trade price axis.

### Rebin:

### Goals:

As various orders are added and removed, the axes 200 adjusts its range based on the order book and the recent trades. We want characterize the calculated bin increments that facilitate us to cover the desired range with a number of bins close to the desired ideal

The increment should be a nice number raised to some power of 10: e.g. $1, $0.1, $0.01, $0.05, $0.5, etc . . . , for example

Current nice values allow increments such as 0.01, 0.02, 0.05, 0.1, 0.2, 0.5, 1, 2, 5, 10, 20, 50 . . .

Given the desired min and max values:

```
Determine an initial exponent as the floor of the base
10 log of (the range/ideal#bins),
matching the increment power.
While the # of too many/few bins is
decreasing (from the previous iteration):
  Determine the bin increment
  Determine the # resulting bins
  # extra bins = # resulting − ideal#
  If too many bins:
    Increase the increment size to the next nice value
  Else
    Decrease the increment size to the next nice value
```

### Placement Module 403

Referring to FIG. 5a, the placement module 403 is used to position the respective surfaces 18 in association with the determined axes 200, such that the data 14 displayed on one surface 18 aligns with similar data 14 displayed on another surface 18 that shares the common axis 200 (or common axes 200). For example, the trading activity surface 206 is positioned with respect to the pricing axis 200b and the order book surface 204 is also positioned with respect to the same pricing axis 200b, such that each trade on the one surface 18 at a designated price is aligned with any corresponding book orders on the other surface 18 at the same designated price. Similarly, the height of all of the trades and book orders are positioned on the surfaces 18 such that each bar of the same height is equal in height (as perceivable by the user) for all surfaces 18 concerned.

### Frequency Module 404

Referring again to FIG. 10, the frequency module 404 is used to determine the frequency for the financial instrument data 14 to be updated in representation 10, based on predefined update periods (e.g. real time, every 5 seconds, etc.) and/or in the event of certain predefined trading activity occurring. Examples of the events exceeding (rising above or dropping below) a certain threshold such as but not limited to: number of book orders; specified price; specified volume; unusual variability in rate of change of volume/prices; etc.

The frequency module 404 also determines the generic timing of the financial instrument data 14 updates, as well as potentially the timing for collection of the data 14 from the sources 15. The module 404 can also be responsible for timing the generation/update of the report 19.

The frequency updates is also related to a conveyor belt principle for the stated time range of the time axis 200a. For example, the time range can stay fixed at a specified time period, say 2 hrs give or take 10 minutes depending on dynamic trading data 14 considerations as discussed above, therefore labelling of the time axis 200a will be updated to show the same time range but with different labels indicating the time range extending back from the time of the last trade (e.g. indicated by indicator 311).

Accordingly, the data 14 content of the trade surface 206 of the representation 10 also updates with each new trade. The trade surface 206 is similar to a price chart—with the long axis indicating time 200a and the shorter axis indicating price 200b. After each update interval, if there has been a new trade, a new bar 314 will appear at the right end indicating the last trade price and any bars 314 at the other end of the time axis 200a that fall outside of the specified time range will be removed or otherwise drop off of the surface 206. Accordingly, the sequence of bars 314 over time shows the trade history of particular financial instrument(s).

### Report Module 408

The report module 408 is configured for assembling calculated measures 300, 302, 304, 306, 308, 310, 311, 312, 313, 314 and snap shots of the representation 10 for inclusion, where appropriate, in the report 19. The module 408 can perform sorting of the selected financial instruments 12 in the report 19 as to which specific financial instruments data 14 are to be included in the report 19, as desired.

In terms of sorting, the report module 408 can group financial instruments by sector or any other defined grouping, as desired.

It is recognised that the modules 125, 400, 402, 403, 404, 408, 410 of the tool 12 can be configured to operate independently of an administrator (not shown) once configured and/or to interact with the user/administrator though the user interface 108 (see FIG. 2) of the computing device 101, in order to carry out the intended functionality and related operations of the tool 12. Further, it is recognised that the modules 125, 400, 402, 403, 404, 408, 410 can be configured to operate interactively as shown, the operations/functionality of the selected modules 125, 400, 402, 403, 404, 408, 410 can be combined or the operations/functionality of the selected modules 125, 400, 402, 403, 404, 408, 410 can be further subdivided, as desired. Further, it is recognised that the modules 125, 400, 402, 403, 404, 408, 410 can communicate or otherwise obtain their calculated results from one another or can store their respective calculated results in the storage 102 for subsequent retrieval by another module 125, 400, 402, 403, 404, 408, 410 there-from.

We claim:

1. A method for monitoring temporally dependent performance of at least one financial instrument in a marketplace including price quantities for executed and unexecuted trades of the at least one financial instrument, the method comprising the acts of:
receiving temporally dependent financial data including the price quantities of the at least one financial instrument;
determining a first common price scale configured for visually distinguishing the price quantities of both the executed and unexecuted trades;
determining a first plurality of shapes configured for visually distinguishing the executed trades on a trading activity surface and determining a second plurality of shapes configured for visually distinguishing the unexecuted trades on an order book surface, each of the shapes of the first and second plurality of shapes positioned on their respective surface with respect to the first common price scale to correspond to the price quantity associated with the trade represented by the shape; and
generating a visual representation configured for portraying the positioned shapes on a visual interface, the visual representation including the trading activity surface located adjacent to the order book surface, such that the trading activity surface and the order book surface are visually aligned with respect to the first common price scale.

2. The method of claim 1 further comprising the act of determining a time scale configured for visually distinguishing the temporal dependence of the executed trades such that the each of the shapes of the first plurality of shapes are positioned on the trading activity surface with respect to the time scale to correspond to a time quantity associated with the executed trade.

3. The method of claim 2 further comprising the act of determining at least one volume scale configured for visually distinguishing at least some of volume quantities included in the financial data, such that each of the shapes of the first and second plurality of shapes are sized to correspond to the volume quantity associated with the trade represented by the shape.

4. The method of claim 3 further comprising the act of updating the positions and sizes of the second plurality of shapes on the order book surface to reflect changes in the price and volume quantities of the unexecuted trades, such that the changes to the first plurality of shapes and the changes to the second plurality of shapes are done concurrently.

5. The method of claim 2, wherein the shapes are selected from the group comprising: one-dimensional; two-dimensional; and three-dimensional.

6. The method of claim 4, wherein the volume scale is common for the first plurality of shapes and the second plurality of shapes for determining the magnitude of the volume quantity of each of the shapes.

7. The method of claim 6, wherein the shapes are three-dimensional bars.

8. The method of claim 6 further comprising the act of aggregating the price and volume quantities for two or more of the executed trades in one of the shapes of the first plurality of shapes.

9. The method of claim 8 further comprising the act of aggregating the price and volume quantities for two or more of the unexecuted trades in one of the shapes of the second plurality of shapes.

10. The method of claim 9, wherein each of the aggregated unexecuted trades is visually distinguished in the one of the shapes as a respective portion of the one of the shapes proportional to the percentage volume of the aggregated volume quantity.

11. The method of claim 6 further comprising the act of determining a second price scale different from the first price scale, the second price scale for assigning to the order book surface and the first price scale for assigning to the trading activity scale, such that the price scales are visually aligned using an expanded portion for visually linking the first price scale with the second price scale, the expanded portion displayed between the adjacent surfaces.

12. The method of claim 11 further comprising the act of determining an indicator region configured for positioning on the trading activity surface and for connecting to the expanded portion, the indicator region for representing the second price scale on the trading activity surface.

13. The method of claim 12 further comprising the act of overlapping at least some of the shapes of the first plurality of shapes on the trading activity surface, such that the overlapped shapes are positioned laterally on the trading activity surface with respect to one another.

14. The method of claim 6 further comprising the act of recalculating a parameter of the price scale due to temporally dependent changes in the financial data.

15. The method of claim 14, wherein the changes in the financial data are selected from the group comprising: the executed trades and the unexecuted trades.

16. The method of claim 15, wherein the parameter is selected from the group comprising: highest price value; lowest price value; and overall price range.

17. The method of claim 6 further comprising the act of recalculating a parameter of the volume scale due to temporally dependent changes in the financial data.

18. The method of claim 17, wherein the parameter is selected from the group comprising: highest volume value; lowest volume value; and overall volume range.

19. The method of claim 6 further comprising the act of generating a report including at least some of the elements of the visual representation, the report configured for sending to a requestor of the report.

20. The method of claim 19, wherein the report includes data for one or more of the financial instruments selected from the group comprising: temporal statistics; price statistics; and volume statistics.

21. A system for monitoring temporally dependent performance of at least one financial instrument in a marketplace including price quantities for executed and unexecuted trades of the at least one financial instrument, the system comprising:
an interface for receiving temporally dependent financial data including the price quantities of the at least one financial instrument;
a configuration module for determining a first common price scale configured for visually distinguishing the price quantities of both the executed and unexecuted trades;
a placement module for determining a first plurality of shapes configured for visually distinguishing the executed trades on a trading activity surface and for determining a second plurality of shapes configured for visually distinguishing the unexecuted trades on an order book surface, each of the shapes of the first and second plurality of shapes positioned on their respective surface with respect to the first common price scale to correspond to the price quantity associated with the trade represented by the shape; and
an update module for generating a visual representation configured for portraying the positioned shapes on a visual interface, the visual representation including the trading activity surface located adjacent to the order book surface, such that the trading activity surface and the order book surface are visually aligned with respect to the first common price scale.

22. The system of claim 21 further comprising the configuration module configured for determining a time scale for visually distinguishing the temporal dependence of the executed trades such that the each of the shapes of the first plurality of shapes are positioned on the trading activity surface with respect to the time scale to correspond to a time quantity associated with the executed trade.

23. The system of claim 22 further comprising the configuration module configured for determining at least one volume scale configured for visually distinguishing at least some of volume quantities included in the financial data, each of the shapes of the first and second plurality of shapes sized to correspond to the volume quantity associated with the trade represented by the shape.

24. The system of claim 23 further comprising the placement module configured for updating the positions and sizes of the second plurality of shapes on the book order surface to reflect changes in the price and volume quantities of the unexecuted trades, such that the changes to the first plurality of shapes and the changes to the second plurality of shapes are done concurrently.

25. The system of claim 22, wherein the shapes are selected from the group comprising: one-dimensional; two-dimensional; and three-dimensional.

26. The system of claim 24, wherein the volume scale is common for the first plurality of shapes and the second plurality of shapes for determining the magnitude of the volume quantity of each of the shapes.

27. The system of claim 26, wherein the shapes are three-dimensional bars.

28. The system of claim 26 further comprising the placement module configured for aggregating the price and volume quantities for two or more of the executed trades in one of the shapes of the first plurality of shapes.

29. The system of claim 28 further comprising the placement module configured for aggregating the price and volume quantities for two or more of the unexecuted trades in one of the shapes of the second plurality of shapes.

30. The system of claim 29, wherein each of the aggregated unexecuted trades is visually distinguished in the one of the shapes as a respective portion of the one of the shapes proportional to the percentage volume of the aggregated volume quantity.

31. The system of claim 26 further comprising the configuration module configured for determining a second price scale different from the first price scale, the second price scale for assigning to the order book surface and the first price scale for assigning to the trading activity scale, such that the price scales are visually aligned using an expanded portion for visually linking the first price scale with the second price scale, the expanded portion displayed between the adjacent surfaces.

32. The system of claim 31 further comprising the placement module configured for determining an indicator region configured for positioning on the trading activity surface and for connecting to the expanded portion, the indicator region for representing the second price scale on the trading activity surface.

33. The system of claim 32 further comprising the placement module configured for overlapping at least some of the shapes of the first plurality of shapes on the trading activity surface, such that the overlapped shapes are positioned laterally on the trading activity surface with respect to one another.

34. The system of claim 26 further comprising the configuration module configured for recalculating a parameter of the price scale due to temporally dependent changes in the financial data.

35. The system of claim 34, wherein the changes in the financial data are selected from the group comprising: the executed trades and the unexecuted trades.

36. The system of claim 35, wherein the parameter is selected from the group comprising: highest price value; lowest price value; and overall price range.

37. The system of claim 26 further comprising the configuration module configured for recalculating a parameter of the volume scale due to temporally dependent changes in the financial data.

38. The system of claim 37, wherein the parameter is selected from the group comprising: highest volume value; lowest volume value; and overall volume range.

39. The system of claim 26 further comprising the configuration module configured for generating a report including al least some of the elements of the visual representation, the report configured for sending to a requestor of the report.

40. The system of claim 39, wherein the report includes data for one or more of the financial instruments selected from the group comprising: temporal statistics; price statistics; and volume statistics.

41. The system of claim 40, wherein the unexecuted trades are selected from the group comprising: order and limit order.

42. The system of claim 22 further comprising the placement module configured for updating the positions of the first plurality of shapes on the trading activity surface to reflect changes in the respective time quantities according to the time scale.
